(19) United States
(12) Patent Application Publication
(10) Pub. No.: US 2017/0023436 A1
(43) Pub. Date: Jan. 26, 2017

(54) TESTING SYSTEM AND TESTING METHOD USING THE SAME

(71) Applicant: GINTECH ENERGY CORPORATION, Miaoli County (TW)

(72) Inventors: Chung-Ming LEE, Miaoli County (TW); Yu-Chern LIU, Miaoli County (TW); Yi-Chao HUANG, Miaoli County (TW); Yong-Chi YANG, Miaoli County (TW)

(21) Appl. No.: 14/937,837

(22) Filed: Nov. 10, 2015

(30) Foreign Application Priority Data
Jul. 21, 2015 (TW) 104123590

(51) Int. Cl. G01M 3/32

(52) U.S. Cl. CPC G01M 3/3209

(57) ABSTRACT

A testing system connected to a gas cylinder and includes a pressure detector, a temperature detector, and a controller. The pressure detector is configured to detect a pressure of a stored gas in the gas cylinder. The temperature detector is configured to detect a temperature of the stored gas in the gas cylinder. The controller is configured to calculate variations in the pressure and the temperature of the stored gas and to determine whether a stored state of the stored gas is present within a predetermined range according to the variances in the pressure and the temperature of the stored gas.

### RELATED APPLICATIONS

This application claims priority to Taiwanese Application Serial Number 104123590, filed Jul. 21, 2015, which is herein incorporated by reference.

### BACKGROUND

Technical Field

The present disclosure relates to a testing system and a testing method using the same.

Description of Related Art

In the production line nowadays, arranging a gas supply is an important part of the design of the production line. In a piping design of a production line, a gas-supply system is established in a region of the factory building, and gas cylinders are placed at this region. In the production process, the production lines are connected to the gas-supply system via pipes, such that the gas provided by the gas-supply system can be transported into each of the production lines. In order to supply the gas smoothly, two gas cylinders containing the same gas are placed in the same region, and both of the two cylinders are connected to a gas-supply pipe.

When one of the gas cylinders is used as a gas-supply source, another one of the gas cylinders is used as a backup gas cylinder. When usage quantity of the gas stored in the gas cylinder used as the gas-supply source is not enough, the pipe is switched to connect with the backup gas cylinder as another gas-supply source, and the gas cylinder has lack of usage quantity of the gas is replaced. After replacing the gas cylinder, the replaced gas cylinder is tested to check a stored state thereof. Next, as the stored state of the replaced gas cylinder has been checked as being normal, the replaced gas cylinder is taken into the gas-supply system and used as the gas-supply source. However, during the replacement operation, when a situation that a user operates careless or judges in error occurs, it may cause a disaster.

### SUMMARY

An aspect of the present disclosure provides a testing system and a testing method using the same, the testing system and the testing method can determine whether a leakage state of a stored gas is normal through an initial pressure, an initial temperature, a detecting pressure, and a detecting temperature of the stored gas. By including the temperature of the stored gas into the calculations for the leakage state of the stored gas, the determination of the testing system with respect to the leakage state of the stored gas is more accurate, thereby reducing the possibility of a gas disaster.

An aspect of the present disclosure provides a testing system, in which the testing system is connected to a gas cylinder and includes a pressure detector, a temperature detector, and a controller. The pressure detector is configured to detect a pressure of a stored gas in the gas cylinder. The temperature detector is configured to detect a temperature of the stored gas in the gas cylinder. The controller is configured to calculate variations in the pressure and the temperature of the stored gas and to determine whether a stored state of the stored gas is present within a predetermined range according to the variances in the pressure and the temperature of the stored gas.

In some embodiments, the testing system further includes a gas-testing pipe connected to the gas cylinder. The testing system is configured to provide the gas cylinder with a test gas via the gas-testing pipe, and the pressure detector and the temperature detector respectively detect the pressure and the temperature of the stored gas through detecting a pressure and a temperature of the test gas.

In some embodiments, detections performed by the pressure detector and the temperature detector are performed simultaneously.

An aspect of the present disclosure provides a testing method for a testing system, the testing method includes a number of steps. An initial pressure and an initial temperature of a stored gas in a gas cylinder are detected. A detecting pressure and a detecting temperature of the stored gas are detected and recorded according to a test frequency. The detecting pressure and the detecting temperature are recalled to a controller and the stored gas is determined whether a stored state of the stored gas is present within a predetermined range according to relationships among the initial pressure, the initial temperature, the detecting pressure, and the detecting temperature.

In some embodiments, the stored state of the stored gas includes a leakage state of the stored gas. The testing method further includes a step of determining whether the gas cylinder is used as a gas supply source according to whether the leakage state of the stored gas in the gas cylinder is present within the predetermined range.

In some embodiments, the stored state of the stored gas includes a leakage state of the stored gas. The step of determining whether the stored state of the stored gas is present within the predetermined range includes a number of steps. A state value of the leakage state of the stored gas is calculated according to proportional relationships among the initial pressure, the initial temperature, the detecting pressure, and the detecting temperature of the stored gas. The state value is determined whether the state value is present within the predetermined range.

In some embodiments, the step of calculating the state value of the stored gas includes a number of steps. A ratio of the initial pressure to the initial temperature is calculated, in which a proportional relationship between the initial pressure and the initial temperature is a first ratio. A ratio of the detecting pressure and the detecting temperature is calculated, in which a proportional relationship between the detecting pressure and the detecting temperature is a second ratio. The state value is calculated according to a difference between the first ratio and the second ratio.

In some embodiments, the step of calculating the state value of the stored gas includes a number of steps. A product of the initial pressure and the detecting temperature is calculated to obtain a first product. A product of the detecting pressure and the initial temperature is calculated to obtain a second product. The state value is calculated according to a difference between the first product and the second product.

In some embodiments, the testing method further includes a number of steps. The first product to calculate a state variation rate divides the state value. The state variation rate is determined whether the state variation rate is present within the predetermined range.

In some embodiments, the testing method further includes a number of steps. A connector disposed on the gas cylinder is provided with a test gas and the initial pressure and the initial temperature of the stored gas is recorded through an initial test pressure and an initial test temperature of the test gas. A detecting test pressure and a detecting test temperature of the test gas are detected and recorded according to the test frequency, and the detecting pressure and the detecting temperature of the stored gas are recorded through the detecting test pressure and the detecting test temperature of the test gas.

### BRIEF DESCRIPTION OF THE DRAWINGS

FIG. 1 is a schematic diagram of a testing system disposed in a gas-supply system according to a first embodiment of the present disclosure;

FIG. 2 is a flowchart of a testing method for a testing system illustrated in FIG. 1; and

FIG. 3 is a schematic diagram of a testing system disposed in a gas-supply system according to a second embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It will be understood that, although the terms first, second, third etc. may be used herein to describe various elements, components, regions, layers and/or sections, these elements, components, regions, layers and/or sections should not be limited by these terms.

As previously mentioned, after replacing a gas cylinder disposed in a gas-supply system, the replacing gas cylinder tested to check a stored state thereof, so as to determine whether the stored state is normal. Next, as the stored state of the replacing gas cylinder is checked as being normal, the replacing gas cylinder is used as a gas-supply source. However, during the replacement operation, when a situation that a user operates careless or judges in error occurs, it may produce an extra cost or risk. Moreover, a disaster may happen due to poor judgment.

Therefore, an aspect of the present disclosure provides a testing system and a testing method using the same, the testing system and the testing method can determine whether a leakage state of a stored gas is normal through the pressure and the temperature of the stored gas. By including the temperature of the stored gas into the calculation for the leakage state of the stored gas, the determination of the testing system with respect to the leakage state of the stored gas can be more accurate.

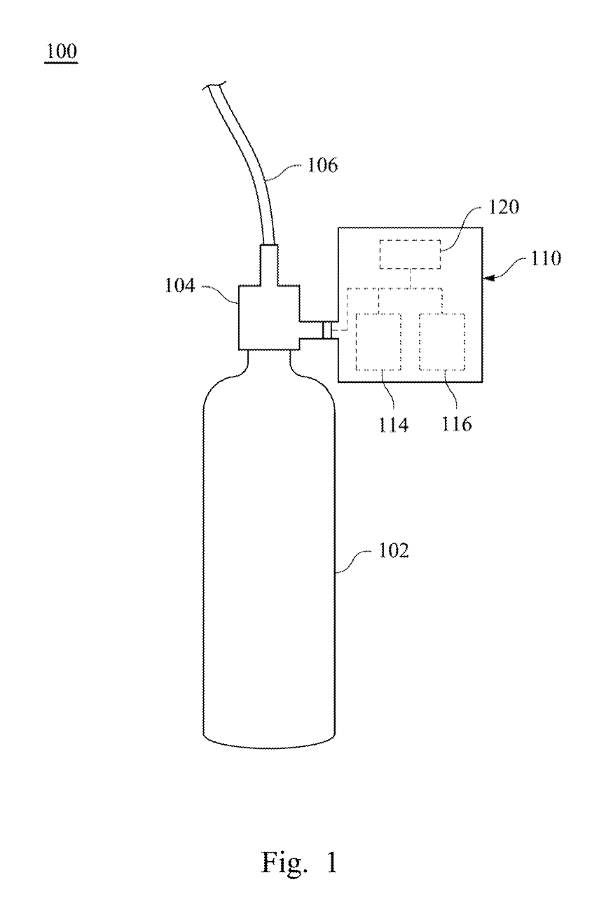

FIG. 1 is a schematic diagram of a testing system 110 disposed in a gas-supply system 100 according to a first embodiment of the present disclosure. The gas-supply system 100 includes a gas cylinder 102, a connector 104, a gas transport pipe 106, and the testing system 110 in which the gas cylinder 102 is a gas cylinder that is placed into the gas-supply system 100 for replacing another one and to be tested. A stored gas is stored in the gas cylinder 102. The connector is disposed on the gas cylinder 102. The gas transport pipe 106 is connected with the gas cylinder 102 through the connector 104 and commutes the stored gas in the gas cylinder 102. When the gas cylinder 102 is used as a gas-supply source of the gas-supply system 100 the gas transport pipe 106 is configured to transport the stored gas in the gas cylinder 102.

The testing system 110 is connected to the gas cylinder 102 through the connector 104 and includes a pressure detector 114, a temperature detector 116, and a controller 120. The pressure detector 114 is configured to detect a pressure of the stored gas in the gas cylinder 102. The temperature detector 116 is configured to detect a temperature of the stored gas in the gas cylinder 102. The controller 120 is configured to calculate variations in the pressure and the temperature of the stored gas and to determine whether a stored state of the stored gas is present within a predetermined range according to the variances in the pressure and the temperature of the stored gas.

When the gas cylinder 102 is placed in the gas-supply system 100 for replacing another one, the gas cylinder 102 placed in the gas-supply system 100 may have an unacceptable state, for example, a gas leakage state in an abnormal state or an over high state. In this regard, when the gas cylinder 102 is placed in the gas-supply system 100 for replacing another one, the stored gas in the gas cylinder 102 can be tested by the testing system 110, so as to determine whether a stored state of the stored gas is normal. In some embodiments, the stored state of the stored gas can include a leakage state of the stored gas. After the stored state of the stored gas is determined as being normal, the gas cylinder 102 can be used as a gas-supply source of the gas-supply system 100 and start to supply the gas.

In other words, in order to take the gas cylinder 102 as the gas-supply source under a safety condition and reduce a possibility of misjudging the gas leakage state, the gas cylinder 102 can be tested by the testing system 110 during a period after the gas cylinder 102 is placed in the gas-supply system 100 for replacing another one and before the gas cylinder 102 is taken as the gas-supply source. For example, the testing system 110 can determine whether the gas cylinder 102 is used as a gas-supply source according to whether the leakage state of the stored gas in the gas cylinder 102 is present within a predetermined range. The following descriptions are provided with respect to a testing method for the testing system 110.

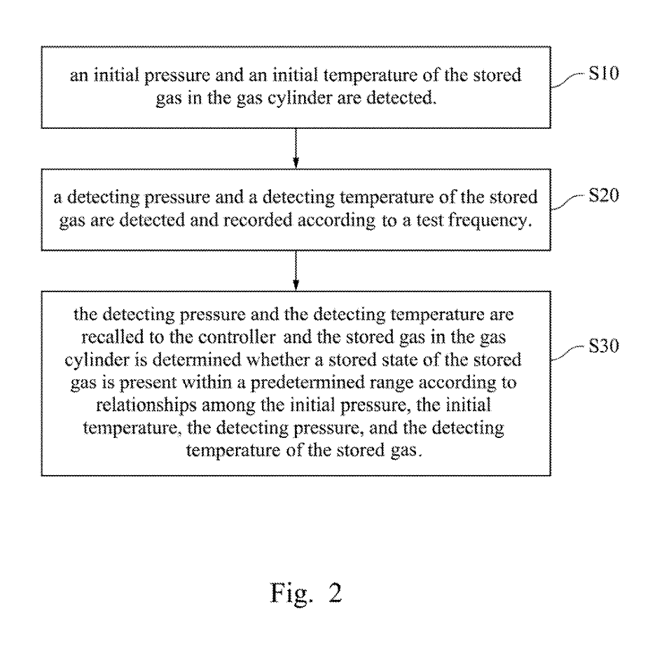

FIG. 2 is a flowchart of a testing method for a testing system 110 illustrated in FIG. 1. The testing method for the testing system 110 includes steps S10-S30. The method begins with the step S10 in which an initial pressure and an initial temperature of the stored gas in the gas cylinder 102 are detected. The method continues with the step S20 in which a detecting pressure and a detecting temperature of the stored gas are detected and recorded according to a test frequency. The method continues with the step S30 in which the detecting pressure and the detecting temperature are recalled to the controller 120 and the stored gas in the gas cylinder 102 is determined whether a stored state of the stored gas is present within a predetermined range according to relationships among the initial pressure, the initial temperature, the detecting pressure, and the detecting temperature of the stored gas. As previously described, the stored state of the stored gas can include the leakage state of the stored gas.

According to the ideal gas law, when a volume and a mole number of a gas are constant, a pressure of the gas is proportional to a temperature of the gas. Thus, the background temperature in the gas-supply system 100 may affect the detecting result with respect to the pressure of the stored gas. For example, even under a condition in which the gas leakage does not occur, the result with respect to the detecting pressure of the gas may be different due to a variance in the temperature. Therefore, in the present embodiment, the temperature of the stored gas is included into a calculation for the leakage state of the stored gas by the testing system 110, such that the determination performed by the testing system 110 with respect to the leakage state of the stored gas can be more accurate. The descriptions are provided with respect to state the calculation for the leakage state of the stored gas. In addition, for making the descriptions succinct, the initial pressure, the initial temperature, the detecting pressure, and the detecting temperature are respectively marked as P1, T1, P2, and T2.

In the present embodiment, the step S30 of the testing method further includes a number of steps. A state value of the leakage state of the stored gas is calculated according to proportional relationships among the initial pressure P1, the initial temperature T1, the detecting pressure P2, and the detecting temperature T2 of the stored gas. Next, the state value is determined whether the state value is present within the predetermined range.

In some embodiments in which the state value of the leakage state of the stored gas is calculated, the step of calculating the state value of the leakage state of the stored gas includes a number of steps. A ratio of the initial pressure P1 to the initial temperature T1 is calculated, in which a proportional relationship between the initial pressure P1 and the initial temperature Ti is a first ratio. Thus, the first ratio is equal to P1/T1. A ratio of the detecting pressure P2 and the detecting temperature T2 is calculated, in which a proportional relationship between the detecting pressure P2 and the detecting temperature T2 is a second ratio. Thus, the second ratio is equal to P2/T2. Next, the state value is calculated according to a difference between the first ratio and the second ratio. Thus, the state value is equal to [(P1/T1)−(P2/T2)].

When the stored state of the stored gas is detected, the predetermined range of the stored gas can be set first. For example, this predetermined range can be taken as a leak-testing range, and this leak-testing range is set as a value A. A person having ordinary skill in the art may set the value A according to the unit of the pressure. For example, under a condition in which the predetermined leak rate is 2.69*10⁻⁵ atm-cc/sec and the predetermined testing time is 4 hours, the leak-testing value is 0.4 Kg/cm². Under this condition, the value A can be set by dividing the 0.4 Kg/cm² by the mean monthly temperature of the background in which the gas-supply system 100 is located, for example, the mean monthly temperature may be 25 degrees celsius. However, the value A set as above is not limited thereto. A person having ordinary skill in the art may set the value A according to a safety factor of a gas cylinder.

Next, the state value is compared with the value A. When the state value is smaller than the value A, the leakage state of the stored gas is regard as being normal. On the contrary, when the state value is greater than the value A, the leakage state of the stored gas is regard as being abnormal. Furthermore, since the testing system 110 detects the detecting pressure and the detecting temperature according to the test frequency, the detection of the stored gas in the gas cylinder 102 can be taken as a real-time detection. For example, when the test frequency is twice per second, the detecting frequency of the testing system 100 with respect to the leakage state of the stored gas is twice per second as well. Furthermore, in some embodiments, the detections performed by the pressure detector 114 and the temperature detector 116 with respect to the stored gas in the gas cylinder 102 are performed simultaneously.

In other words, with the testing method of the present disclosure, the pressure and the temperature of the stored gas are included as the calculating parameters. Therefore, even though the gas-supply system is located at an environment with the time-dependent temperature, with including the temperature of the stored gas as the calculating parameter, the testing method can determine whether the leakage state of the stored gas is normal. Moreover, with the testing method of the present disclosure, the danger caused by the misjudgement of the operator is reduced, and the risk and the cost of replacing the gas cylinder are reduced.

In addition, the state value can be calculated by another way. In some embodiments in which the state value of the leakage state of the stored gas is calculated, calculating the state value of the stored gas includes a number of steps. A product of the initial pressure P1 and the detecting temperature T2 is calculated to obtain a first product, and thus the first product is equal to P1*T2. A product of the detecting pressure P2 and the initial temperature T1 is calculated to obtain a second product, and thus the second product is equal to P2*T1. The state value is calculated according to a difference between the first product and the second product, and thus the state value is equal to [(P1*T2)−(P2*T1)].

Similarly, when the stored state of the stored gas is detected, the predetermined range of the stored gas can be taken as the leak testing range and be set as a value B. Next, the state value is compared with the value B. When the state value is smaller than the value B, the leakage state of the stored gas is regard as being normal. On the contrary, when the state value is greater than the value B, the leakage state of the stored gas is regard as being abnormal.

In some embodiments in which the product of the pressure and the temperature is calculated, the predetermined range can be set as a percentages, for example, a percentage C%, and the testing method further includes a number of steps. The first product to calculate a state variation rate divides the state value, and thus the state variation rate is equal to [[(P1*T2)−(P2*T1)]/(P1*T2)]*100%. Next, the state variation rate is determined whether the state variation rate is present within the predetermined range.

In other words, in embodiments in which the state variation rate is calculated, the detecting pressure and the detecting temperature of the stored gas are compared with the initial pressure and the initial temperature of the stored gas by the testing method during the detection, in which the comparing result is calculated as the percentage relationship. With this percentage relationship, the testing method can determine which the leakage state of the stored gas is normal. For example, when the state variation rate of the stored gas is small than the percentage C%, the leakage state of the stored gas is regard as being normal. On the contrary, when the state value is greater than the percentage C%, the state variation rate of the stored gas is regard as being abnormal.

As described above, with the testing method of the present disclosure, the initial pressure, the initial temperature, the detecting pressure, and the detecting temperature are included into the calculation for the leakage state of the stored gas, so as to determine whether the leakage state of the stored gas is normal. In addition, when the leakage state of the stored gas in the gas cylinder is determined as being normal, the gas cylinder is used as a gas-supply source for the gas-supply system.

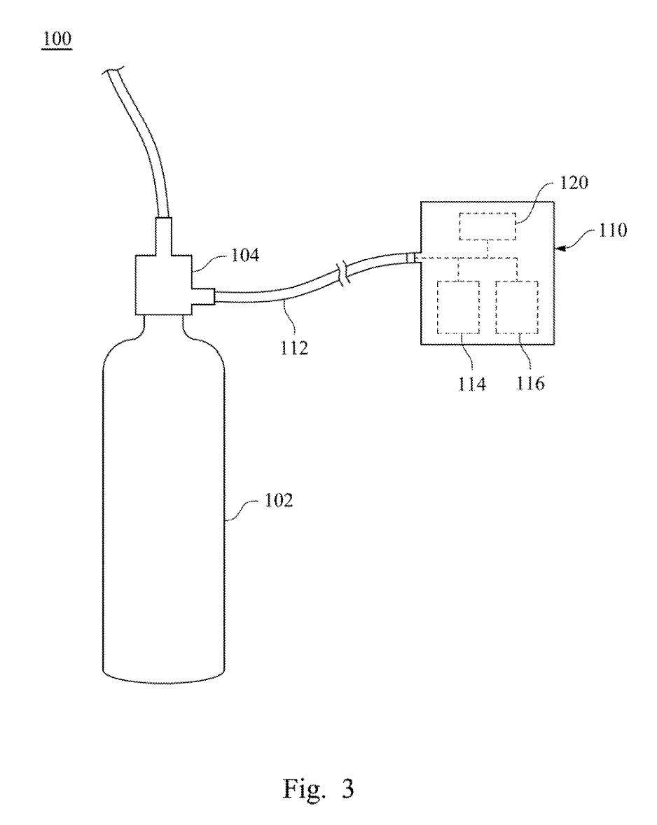

FIG. 3 is a schematic diagram of a testing system 110 disposed in a gas-supply system 100 according to a second embodiment of the present disclosure. The difference between the present embodiment and the first embodiment is that the testing system 110 of the present embodiment detects the pressure and the temperature of the stored gas through a test gas.

In the present embodiment, the testing system 110 further includes a gas-testing pipe 112, in which the gas-testing pipe 112 is connected to the gas cylinder 102. The testing system 110 is configured to provide the gas cylinder 102 with the test gas via the gas-testing pipe 112, and the pressure detector 114 and the temperature detector 116 respectively detect the pressure and the temperature of the stored gas through detecting a pressure and a temperature of the test gas. In addition, in some embodiments, the testing system 110 provides the gas cylinder 102 with nitrogen via the gas-sting pipe 112.

In this regard, when the stored gas in the gas cylinder 102 is detected by the testing system 110, the testing system 110 provides the connector 104 disposed on the gas cylinder 102 with the test gas, and the initial pressure and the initial temperature of the stored gas is recorded through an initial test pressure and an initial test temperature of the test gas. Next, a detecting test pressure and a detecting test temperature of the test gas are detected and recorded according to the test frequency, and the detecting pressure and the detecting temperature of the stored gas are recorded through the detecting test pressure and the detecting test temperature of the test gas.

Similarly, when the initial pressure, the initial temperature, the detecting pressure, and the detecting temperature of the stored gas are obtained, the testing system 110 can determine whether the leakage state of the stored gas in normal, In addition, with the testing method, the stored state of the stored gas can be calculated and obtained through the initial test pressure, the initial test temperature, the detecting test pressure, and the detecting test temperature of the test gas. By the detection with respect to the stored gas using the test gas, the detection result of testing system 110 with respect to the pressure and the temperature can be more accurate.

As described above, the testing method of the present disclosure can determine whether the leakage state of the stored gas is normal through the initial pressure, the initial temperature, the detecting pressure, and the detecting temperature of the stored gas. Moreover, by including the temperature of the stored gas into the calculation for the leakage state of the stored gas, the judgment of the testing system with respect to the leakage state of the stored gas is more accurate, thereby reducing the possibility of the gas disaster. In addition, the testing system of the present disclosure can further detect the pressure and the temperature of the stored gas through the test gas, such that the detection result of testing system with respect to the pressure and the temperature can be more accurate.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of the present disclosure provided they fall within the scope of the following claims.

What is claimed is:

1. A testing system connected to a gas cylinder, comprising:
a pressure detector configured to detect a pressure of a stored gas in the gas cylinder;
a temperature detector configured to detect a temperature of the stored gas in the gas cylinder; and
a controller configured to calculate variations in the pressure and the temperature of the stored gas and to determine whether a stored state of the stored gas is present within a predetermined range according to the variances in the pressure and the temperature of the stored gas.

2. The testing system of claim 1, further comprising a gas-testing pipe connected to the gas cylinder, Therein the testing system is configured to provide the gas cylinder with a test gas via the gas-testing pipe, and the pressure detector and the temperature detector respectively detect the pressure and the temperature of the stored gas through detecting a pressure and a temperature of the test gas.

3. The testing system of claim 1, wherein detections performed by the pressure detector and the temperature detector are performed simultaneously,

4. A testing method for a testing system, comprising:
detecting an initial pressure and an initial temperature of a stored gas in a gas cylinder;
detecting and recording a detecting pressure and a detecting temperature of the stored gas according to a test frequency; and
recalling the detecting pressure and the detecting temperature to a controller and determining whether a stored state of the stored gas is present within a predetermined range according to relationships among the initial pressure, the initial temperature, the detecting pressure, and the detecting temperature.

5. The testing method of claim 4, wherein the stored state of the stored gas comprises a leakage state of the stored gas, and the testing method further comprises:
determining whether the gas cylinder is used as a gas-supply source according to whether the leakage state of the stored gas in the gas cylinder is present within the predetermined range.

6. The testing method of claim 4, wherein the stored state of the stored gas comprises a leakage state of the stored gas, and the step of determining whether the stored state of the stored gas is present within the predetermined range comprise:
calculating a state value of the leakage state of the stored gas according to proportional relationships among the initial pressure, the initial temperature, the detecting pressure, and the detecting temperature of the stored gas; and
determining whether the state value is present within the predetermined range.

7. The testing method of claim 6, wherein the step of calculating the state value of the stored gas comprises:
calculating a ratio of the initial pressure to the initial temperature, wherein a proportional relationship between the initial pressure and the initial temperature is a first ratio;
calculating a ratio of the detecting pressure and the detecting temperature, wherein a proportional relationship between the detecting pressure and the detecting temperature is a second ratio; and
calculating the state value according to a difference between the first ratio and the second ratio.

8. The testing method of claim 6, wherein the step of calculating the state value of the stored gas comprises:
calculating a product of the initial pressure and the detecting temperature to obtain a first product;
calculating a product of the detecting pressure and the initial temperature to obtain a second product; and
calculating the state value according to a difference between the first product and the second product.

9. The testing method of claim 8, further comprising:
dividing the state value by the first product to calculate a state variation rate; and
determining whether the state variation rate is present within the predetermined range.

10. The testing method of claim 4, further comprising:
providing a test gas with a connector disposed on the gas cylinder and recording the initial pressure and the initial temperature of the stored gas through an initial test pressure and an initial test temperature of the test gas; and
detecting and recording a detecting test pressure and a detecting test temperature of the test gas according to the test frequency and recording the detecting pressure and the detecting temperature of the stored gas through the detecting test pressure and the detecting test temperature of the test gas.
